(19) United States
(12) Patent Application Publication
(10) Pub. No.: US 2024/0086799 A1
(43) Pub. Date: Mar. 14, 2024

(54) DETECTION OF TERMINOLOGY UNDERSTANDING MISMATCH CANDIDATES

(71) Applicant: Microsoft Technology Licensing, LLC, Redmond, WA (US)

(72) Inventors: Torbjørn HELVIK, Olso (NO); Jon MELING, Tromsø (NO); Jan-Ove Almli KARLBERG, Tromsø (NO)

(21) Appl. No.: 17/944,775

(22) Filed: Sep. 14, 2022

(51) Int. Cl. G06Q 10/06

(52) U.S. Cl. CPC G06Q 10/06312

(57) ABSTRACT

The disclosed technology is generally directed to detecting terminology understanding mismatch candidates. In one example of the technology, input content is received. Topics associated with the input content are identified. For each identified topic, topic information that corresponds to the identified topic is obtained. People associated with the input content are identified. For each identified person, person information that corresponds to the identified person is obtained. Based on the obtained topic information and the obtained person information, for each identified person: a level of proficiency of the identified person in each of the identified topics is determined. For each of the identified topics, whether the determined level of proficiency of the identified person meets a threshold that is associated with the identified topic is evaluated. For each determined level of proficiency that does not meet the threshold that is associated with the identified topic, a remedy is suggested.

### BACKGROUND

In many organizations, large groups of people come together to solve problems within an area. An organization may contain large groups of people, spanning different professions and different divisions, where the shared understanding of an area may be very low. Without a shared understanding, any work or agreement that needs to happen may be hampered by deviations from shared understandings. However, there might not be an awareness that there is a lack of shared understanding. The lack of a shared understanding may not be easy to detect and is something that might be unveiled gradually as the work progresses, which may mean that decisions must be revisited to ensure that the decisions are correct.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to detecting terminology understanding mismatch candidates, as follows according to some examples. Input content is received. From a plurality of topics, topics associated with the input content are identified. For each identified topic of the identified topics, from a knowledge base, topic information that corresponds to the identified topic is obtained. People associated with the input content are identified. For each identified person of the identified people, from the knowledge base, person information that corresponds to the identified person is obtained. Based on the obtained topic information and the obtained person information, for each identified person: a level of proficiency of the identified person in each of the identified topics is determined. For each of the identified topics, whether the determined level of proficiency of the identified person meets a threshold that is associated with the identified topic is evaluated. For each determined level of proficiency that does not meet the threshold that is associated with the identified topic, a remedy is suggested.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating an example of a network-connected system;

FIG. 2 is a block diagram illustrating an example of a system for detection of terminology understanding mismatch candidates;

FIG. 3 is a flow diagram illustrating an example process for detection of terminology understanding mismatch candidates;

FIG. 4 is a block diagram illustrating one example of a suitable environment in which aspects of the technology may be employed; and

FIG. 5 is a block diagram illustrating one example of a suitable computing device, according to aspects of the disclosed technology.

### DETAILED DESCRIPTION

A system is used to determine candidates for terminology understanding mismatches that may exist in content due to a lack of shared understanding among people associated with the content.

For example, content may include an acronym that may be interpreted in different ways by different people. For instance, a group of people may use a particular acronym that is easily understood by people in the group based on context. However, a different group of people in another part of the same organization may use the same acronym, but with a completely different meaning. If a communication between the groups that makes use of such an acronym is made through email, through meetings, or through documents, a different meaning may be interpreted by some people in the organization than what was intended.

Acronyms are but one example of terminology that may be interpreted in different ways by different people in different parts of an organization due to a lack of shared understanding. Various terminology may be interpreted in different ways due to a lack of shared understanding. For instance, the word “caching” may mean different things in different contexts. For example, for a group that is building an operating system, the word “caching” may mean something different than a group that is building a web application. And, for groups building a web application, “caching” may mean something different in a client layer than in a back-end service.

As another example, a lack of shared understanding may also occur with regard to familiarity with various projects and the like. If an email references a particular project by name, some recipients might not have familiarity with the specific project being referenced.

In various examples, a system may be used to determine where a lack of shared understanding may cause miscommunication and provide notification of such a potential issue along with suggestions to remedy the issue.

Some examples may operate as follows. Various content from an organization is organized in order to create a knowledge base. In some examples, a machine-learning model is used to create a knowledge base from the content. In other example, the knowledge base is created from the content in another suitable manner. In some examples, a machine-learning model is used to map the content into a semantic space. In other examples, other suitable methods are used by the machine-learning model. When creating or updated the knowledge base, the machine-learning model infers topics from the provided content, and information about the topics is stored in the knowledge base.

The content from which the knowledge base is created includes, for example, documents; websites; various communication including emails, text, instants messages, and the like; recorded videos and other recordings that includes speech that is converted to text; and other suitable content. The knowledge base may include information about each person in the organization. The information for the person that is stored in the knowledge base may indicate a level of proficiency of the person in each of the topics, as determined by the machine-learning model. The knowledge base is updated over time based on new content.

While new content is being created, the content may be input to a system for analysis. The analysis may determine which topics from the knowledge base are included in the content. The analysis may also determine which people are associated with the content that is being created. For example, if an email is being drafted, the associated people may include the author of the email and each of the recipients of the email. The analysis then uses the stored people information in the knowledge base for the associated people to determine the level of proficiency of each of the associated people in each of the topics included in the content. The analysis the determines whether the level of proficiency of each of the people in each of the topics meets a threshold. The analysis then identifies any topics for which at least one of the associated people fails meet the threshold level of proficiency in the topic. For each such topic, there may be mismatches in the understanding of some of the terminology used.

For each such topic, the system may notify the creator of the new content of any result potential terminology understanding mismatches resulting from the lack of shared understanding and suggest potential remedies. The suggestion of remedies may include the identification of candidates for terminology understanding mismatches based on a lack of shared understanding, and suggestions that allow the creator to clarify the terminology being used. Such terminology may include acronyms and other terminology that may be interpreted in different ways by different audiences. The remedy may include a suggestion to clarify which abbreviation of an acronym is correct for this context, suggestions of documents that participants should read, or the like.

### ILLUSTRATIVE SYSTEMS

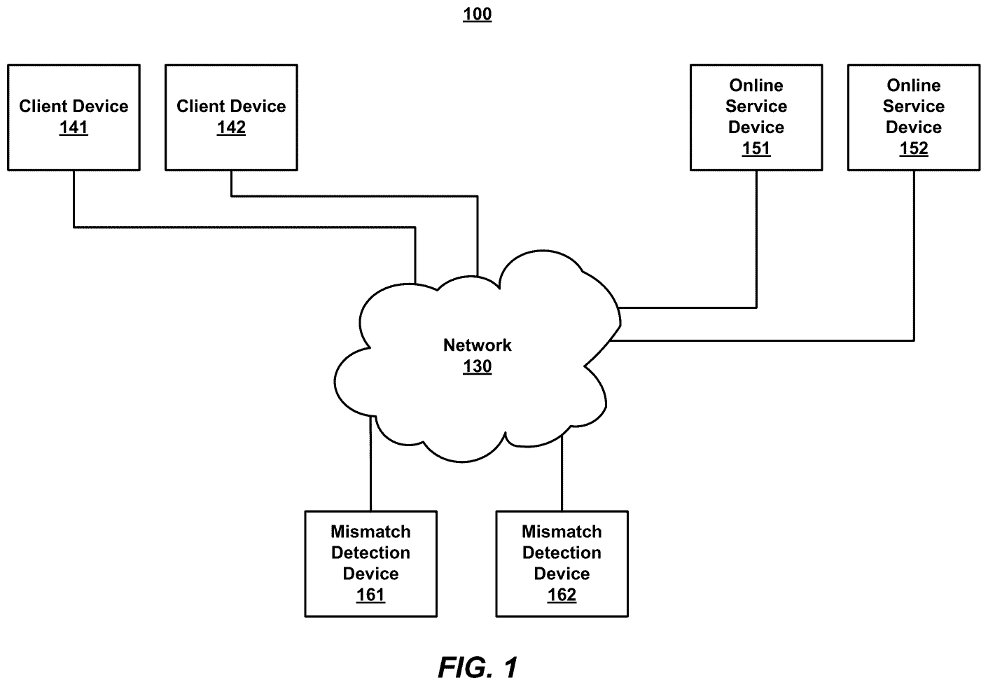

FIG. 1 is a block diagram illustrating an example of a system (100). FIG. 1 and the corresponding description of FIG. 1 in the specification illustrate an example system for illustrative purposes that does not limit the scope of the disclosure. System 100 includes network 130, as well as client devices 141 and 142, online service devices 151 and 152, and mismatch detection devices 161 and 162, which all connect to network 130.

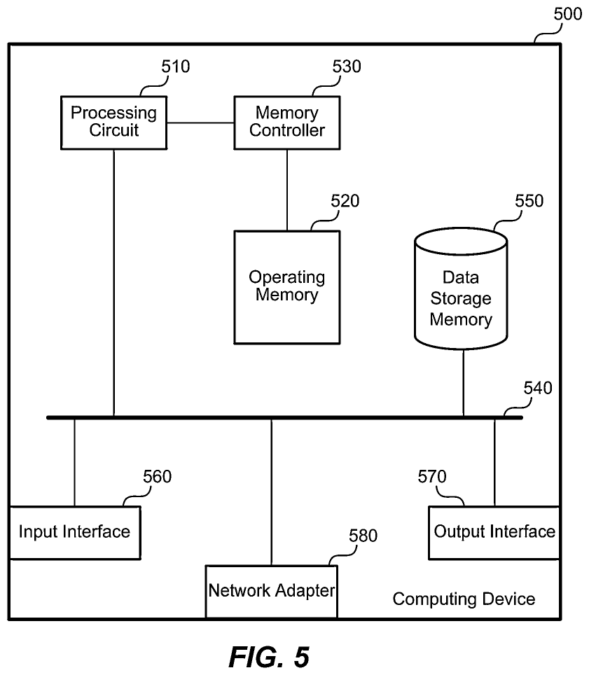

Each of client devices 141 and 142, online service devices 151 and 152, and mismatch detection devices 161 and 162 include examples of computing device 500 of FIG. 5. Online service devices 151 and 152 are part of one or more distributed systems. Mismatch detection devices 161 and 162 are part of one or more distributed systems.

Online service devices 151 and 152 provide one or more services on behalf of users. Among other things, the services provided by online service devices 151 and 152 include providing access to various documents, various forms of communication, and/or the like. The forms of communication may include emails, instant messages, online meetings, and/or the like. A user may use a client device (e.g., client device 141 or 142) to access online services provided by online service devices 151 and 152.

Mismatch detection devices 161 and 162 are part of a system that provides a mismatch detection service that determines candidates for terminology understanding mismatches that may exist in content due to a lack of shared understanding among people associated with content. The mismatch detection service receives content from online service devices 151 and 152. The mismatch detection service includes multiple components, as discussed in greater detail below with regard to particular examples.

Network 130 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T₁, T₂, T₃, and T₄, Integrated Services Digital Networks (ISDNs), Digital Subscriber Lines (DSLs), wireless links including satellite links, and/or other communications links known to those skilled in the art. Furthermore, remote computers and other related electronic devices could be remotely connected to either LANs or WANs via a modem and temporary telephone link. Network 130 may include various other networks such as one or more networks using local network protocols such as 6LoWPAN, ZigBee, or the like. In essence, network 130 may include any suitable network-based communication method by which information may travel among client devices 141 and 142, online service devices 151 and 152, and mismatch detection devices 161 and 162. Although each device is shown connected as connected to network 130, that does not necessarily mean that each device communicates with each other device shown. In some examples, some devices shown only communicate with some other devices/services shown via one or more intermediary devices. Also, although network 130 is illustrated as one network, in some examples, network 130 may instead include multiple networks that may or may not be connected with each other, with some of the devices shown communicating with each other through one network of the multiple networks and other of the devices shown instead communicating with each other with a different network of the multiple networks.

System 100 may include more or less devices than illustrated in FIG. 1, which is shown by way of example only.

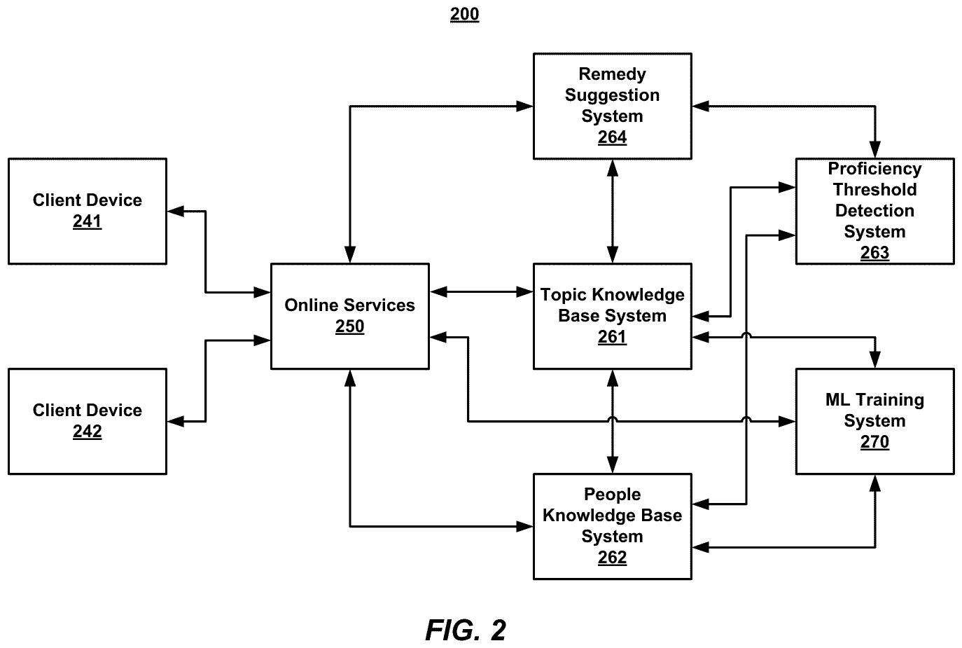

FIG. 2 is a block diagram illustrating an example of a system (200). System 200 may be an example of system 100 of FIG. 1. System 200 is described as follows in accordance with some examples. System 200 includes client device 241, client device 242, online services 250, topic knowledge base system 261, people knowledge base system 262, proficiency threshold detection system 263, mismatch remedy system 264, and machine-learning (ML) training system 270. Online services 250, topic knowledge base system 261, people knowledge base system 262, proficiency threshold detection system 263, mismatch remedy system 264, and ML training system 270 include one or more distributed systems.

Online services 250 provides one or more services on behalf of users, as follows according to some examples. Among other things, the services provided by online services 250 include providing access to various documents, various forms of communication, and/or the like. The forms of communication may include emails, instant messages, online meetings, and/or the like. A user may use a client device (e.g., client device 241 or 242) to access online services provided by online services 250. ML training system 270 provides machine-learning training in order to generate one or more machine-learning models. In various example, ML training system 270 may use unsupervised training methods, supervised training methods, a hybrid of unsupervised training methods, and other suitable training methods to train the machine-learning model. Machine-learning models generated by ML training system 270 may be used by various other system as discussed in greater detail below.

Topic knowledge base system 261, people knowledge base system 262, proficiency threshold detection system 263, and mismatch remedy system 264 may operate as follows in some examples. Topic knowledge base system 261, people knowledge base system 262, proficiency threshold detection system 263, and mismatch remedy system 264 operate together as four components of a mismatch detection system that system that provides a mismatch detection service that determines candidates for terminology understanding mismatches that may exist in content due to a lack of shared understanding among people associated with content and that suggest remedies for potential mismatches.

Users may use and generate various contents via client devices such as client device 241 and client device 242. As discussed above, the content may include various documents, various forms of communication, and/or the like. The forms of communication may include emails, instant messages, websites, online meetings, and/or the like. In some examples, content generated and used by users may be provided by online services 250 to topic knowledge base system 261 and people knowledge base system 262 so that topic knowledge base system 261 and people knowledge base system 262 can provide a knowledge base that includes information about people and topic associated with the content. Topic knowledge base system 261 generates topic information for each topic that is associated with the provided content and stores the generated topic information in the knowledge base. People knowledge base system 262 generates person information for each person that is associated with the provided content and stores the generated person information in the knowledge base.

Topic knowledge base system 261 determines topics associated with the provided content. In some examples, the topic determination is performed by a machine-learning model that was trained by ML training system 270. In some examples, the machine-learning model is trained based on unsupervised machine learning that is augmented by a feedback system in which feedback is obtained from users on the topics generated by the machine-learning model. Topic knowledge base system 261 generates topic information based on the provided content and stores the topic information in the knowledge base. As more content is provided over time, topic knowledge base system 261 provides new topics and updates the existing topic information in the knowledge base based on the new content.

People knowledge base system 262 generates person information for each person that is associated with the provided content. The people associated with the content may include creators of the content, collaborators for the content, readers of the content, recipients of the content, users with which the content have been shared, and/or the like. The person information indicates, for each of the topics determined by topic knowledge base system 261, a level of skill/proficiency of that person for the topic. The level of skill for the person in each topic is determined based on the provided content using a machine-learning model that was trained by ML training system 270. The level of skill for the person may be determined in various ways based on the provided content—factors that may contribute include content that the person has authored or otherwise contributed to, content that the person has read, the amount of time the person has spent reading relevant content, the number of people that the person has engaged in the topic with, the duration of the time period over which the person has engaged the topic, and the like.

The knowledge base is used to keep track of topics used in the content of the organization, and to keep track of the proficiency level of each person that is associated with the organization in each of the topics. The knowledge base is maintained by topic knowledge base system 261 and person knowledge base system 262 and is updated by knowledge base system 261 and person knowledge base system 262 over time. Although machine-learning models were discussed above for determining the topics and generating the people information and the topic information, suitable methods other than machine-learning models may alternatively be used. For instance, in some examples, one or more of the machine-learning models discussed above may be replaced by a suitable algorithm or method, such as a set of heuristics.

In some examples, topic knowledge base system 261 and people knowledge base system 262 may generate topic information and people information as follows. Topic knowledge base system 261 and people knowledge base system 262 map the provided content into a semantic space. After mapping the provided content into a semantic space, topic knowledge base system 261 generates a topic vector for each topic that is associated with the provided content and people knowledge base system 262 generates a person vector for each person that is associated with the provided content. Each of the vectors is a vector of floating-point numbers. The machine-learning model infers the topics from the provided content that is mapped into the semantic space. Topic knowledge base system 261 determines topics associated with the provided content.

In some examples, the topic determination is performed by a machine-learning model that was trained by ML training system 270. In some examples, the machine-learning model is trained based on unsupervised machine learning that is augmented by a feedback system in which feedback is obtained from users on the topics generated by the machine-learning model. A topic vector is generated by topic knowledge base system 261 based on the provided content. The topic information includes the topic vectors, and the people information includes the people vectors. As more content is provided over time, topic knowledge base system 261 provides new topics and updates the existing topic vectors. People knowledge base system 262 generates a person vector for each person that is associated with the provided content. As more content is provided over time, people knowledge base system 261 provides new people vectors as new people are associated with the new contact, and updates the people vectors to update the proficiency levels of the people in each of the topics based on the additional content.

In other examples, the information generated and stored in the knowledge based is generated in another suitable manner.

As discussed above, the topic information and people information is maintained, stored, and used for the detection of mismatch candidates as new content is created by users. When a user is using online services 250 to create new content, online services 250 provides the content that is being created to people knowledge base system 262. Accordingly, people knowledge base system 262 receives the content being created by the user as input content. People knowledge base system 262 determines/identifies people that are associated with the input content. For instance, in the case of an ongoing meeting, the people that are associated with the input content may include attendees of the meeting.

In the case of an email, the people may include the person writing the email and each recipient of the email. More generally, the people associated with the input content may include the person creating the input content, other collaborators to the input content, recipients of the input content, other participants to the input content, users with which the content is being shared, and/or the like. For each person associated with the input content, people knowledge base system 262 obtains the person information for the person.

Topic knowledge base system 261 also receives the input content and analyzes the input content in order to determine/identify which topics are associated with the input content from among the topics stored in the knowledge base. In some examples, identifying which topics that are associated with the input content is accomplished by mapping the input content into the semantic space. In other examples, identifying which topics are associated with the input content is accomplished in another suitable manner. For each topic that is determined to be associated with the input content, topic knowledge base system 261 obtains topic information for the topic from the knowledge database.

The obtained people information is communicated from people knowledge base system 262 to proficiency threshold detection system 263, and the obtained topic information is communicated from topic knowledge base system 261 to proficiency threshold detection system 263. Proficiency threshold detection system 263 then determines/evaluates, for each person that is associated with the input content, for each topic that is associated with the input content, whether the level of proficiency of the person in the topic meets a threshold. In some examples, a fixed threshold is used for each topic independent of the input content. In other examples, the threshold varies depending on the input content, so that input content that requires a deeper understanding of a topic requires a greater level of proficiency to meet the threshold. Proficiency threshold detection system 263 then communicates to remedy suggestion system 264 which topics did not meet the threshold for at least one of the associated people.

Remedy suggestion system 264 receives the input content from online services 260 and receives from proficiency threshold detection system 263 an identification of the topics that did not meet the threshold for at least one of the associated people. Remedy suggestion system 264 then determines potential remedies for the potential mismatches, which are communicated to online services 250 and then in turn to the user that is creating the content.

Remedy suggestion system 264 determines candidates for terminology understanding mismatch based on the topics that were identified as not meeting the threshold for at least one of the associated people The terminology understanding mismatches may include acronyms associated with an identified topic, a word or phrase that is associated with an identified topics that may have a meaning that may be misinterpreted or otherwise misunderstood by people that do not meet the threshold level of proficiency with the identified topic, a project name associated with the topic, and/or the like. Remedy suggestion system 264 then determines one or more suggested remedies for each of the candidate mismatches.

For instance, in the case of an acronym, remedy suggestion system 264 may suggest that the acronym be spelled out, and may suggest a spelled-out version of the acronym determined to be the best candidate by remedy suggestion system 264. In the case of terminology that may be interpreted in different ways by different audiences, remedy suggestion system 264 may suggest that further clarification be provided for the terminology, may suggest particular clarification to be provided for the terminology, or may provide a link to a document that provides further clarification for the terminology. In some examples, remedy suggestion system 264 itself determines such a document and provides a link to the document. In some examples, remedy suggestion system 264 may use additional information to clarify the meaning of terminology that may have different meanings in different contexts, such as the email history of the author, the authorship of documents by the author, and other relevant information.

After one or more suggested remedies are determined by remedy suggestion system 264, remedy suggestion system 264 provides the suggested remedies to online services 250. Online services 250 then communicates the suggested remedies to the user. For instance, in the case of a link to a document, online services 250 may communicate that there may be a lack of shared understanding with regard to particular terminology used, and online services 250 may provide to the user the link to the document, along with a suggestion that the user include the link in the content that is being created.

The mismatch determination and remedy suggestions may be provided for content that is being created in different ways in different examples. In some examples, the mismatch determination and remedy suggestions may be provided after a document or other content is completed. In other examples, the mismatch determination of remedy suggestions may be provided in an ongoing manner while a particular document or other content is being created. For instance, in some examples, while a user is creating a document or other content, online services 250 may determine whether the content has reached a threshold by which the content can be properly analyzed. Once the threshold is reached, the input content is input to people knowledge base system 262 and topic knowledge base system 261 for analysis. Also, as the user continues to work on the input content, the input content may be analyzed again at various times. In some examples, analysis may be provided at a time selected by a user. For example, there may be a button or a menu selection that may be accessed by a user to perform the analysis.

In some examples, for each issue, the system may intelligently determine whether a particular issue has already been addressed, so that the system can avoid suggesting a remedy for an issue that is already resolved in the content. In some examples, a user may be able to mark that a particular issue has been resolved. In some examples, there may be options to exclude some associated people from the determination. For instance, in the case of an email, in some examples, some recipients might not be expected to have a need to understanding technical aspects of the email's text, and could therefore be excluded from the analysis.

The manner in which remedy suggestions are provided may vary in different examples and may vary depending on the content being analyzed. For instance, in the case of an online meeting, a proactive notification may be provided to the organizer of the meeting during the meeting to make the organizer aware of a terminology understanding mismatch candidate and suggest a remedy. The notification may take various forms in various example, such as via a pop-up message, toolkit, or the like. In some examples, instead of providing the notification to the organizer, suggestions may be provided to participants on a per-participant basis, with suggestions provided to a participant that may allow the participant to increase the participant's knowledge in a particular area, such as by providing a link to a relevant document to the participant.

One hypothetical example of the detection of mismatch candidates and remedy suggestion as new content is created by users is given as follows. In this hypothetical example, Alice drafts an email, with Bob and Cedrik as recipients. The system identifies topics in the email that is being drafted. For instance, in this hypothetical example, the email being drafted refers to “project Athena,” and the email also uses the word “caching.” The knowledge base has a topic for project Athena and multiple topics named “caching.” The system determines that “project Athena” is a relevant topic, uses the context of the email to determine which topic for “caching” is relevant to the email, and then retrieves topic information for each of these two topics from the knowledge base. The system also determines that Alice, Bob, and Cedrik are relevant people. The system retrieves information about Alice, Bob, and Cedrick from the knowledge database and determines the level of proficiency of Alice, Bob, and Cedrik in each of the identified topics.

The system determines that Alice and Bob have knowledge about project Athena, but that Cedrick does not. Accordingly, while Alice is drafting the email, the system provides Alice with a suggestion to include, in the email being drafted, a link to a particular document that explains what Project Athena is. The system also provides Alice with a suggested clarification of the word “caching” to include in the email in order to clarify the meaning of the word “caching,” which might otherwise be interpreted by Bob or Cedrik in a different manner than intended by Alice.

In various examples, system 200 may deal with issues of privacy, security, and the like in different manners. In some examples, system 200 does not suggest documents that a user does not have access to. In some examples, matter that is determined to be private, sensitive, or the like may be excluded. In some examples, there may be a tiered model for security, where some topics can only be leveraged if both the recipient and the author have access to the topic. In some examples, users may be able to opt of certain aspects, or may have toggles that may allow them to turn and off various functions of the system with respect to themselves.

### Illustrative Processes

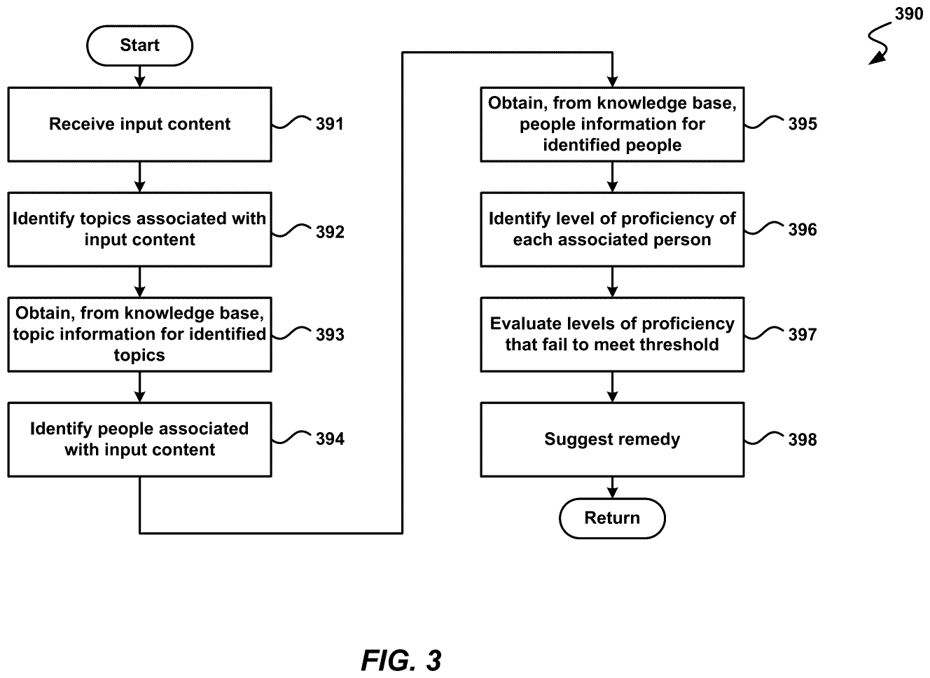

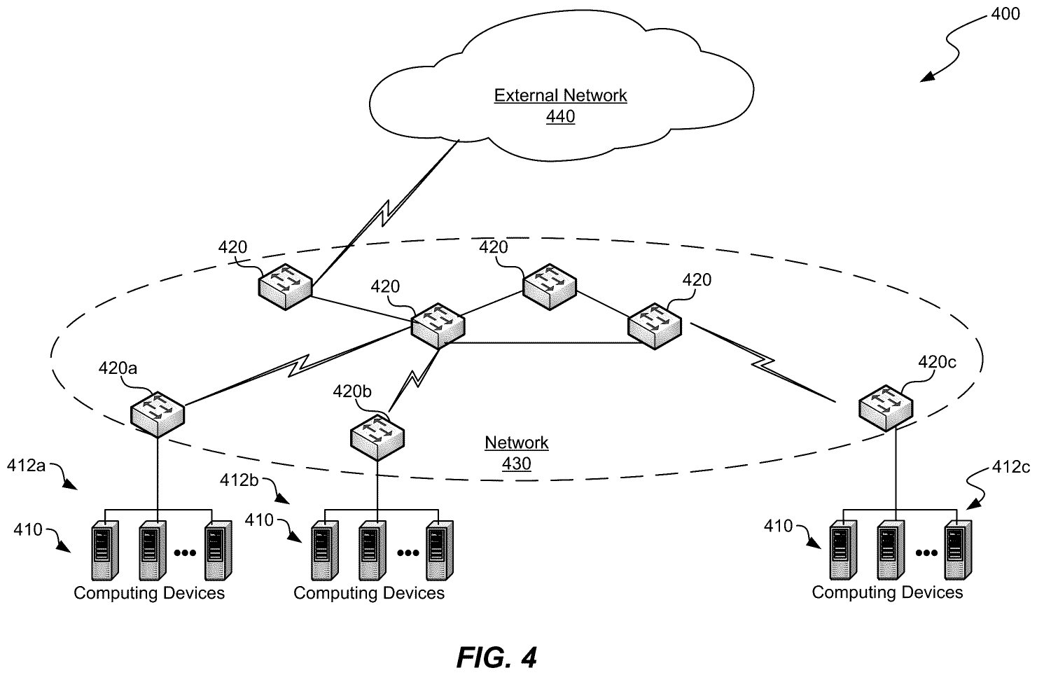

FIG. 3 a diagram illustrating an example dataflow for a process (390) for terminology understanding mismatch candidates. In some examples, process 390 may be performed by an example of one of the mismatch detection devices 161 or 162 of FIG. 1, by an example of one or more components of system 200 of FIG. 2, by an example of device 400 of FIG. 4, or the like. In some examples, process 390 proceeds as follows.

Step 391 occurs first. At step 391, input content is received. As shown, step 392 occurs next. At step 392, from a plurality of topics, topics associated with the input content are identified. As shown, step 393 occurs next. At step 393, for each identified topic of the identified topics, from a knowledge base, topic information that corresponds to the identified topic is obtained. As shown, step 394 occurs next. At step 394, people associated with the input content are identified. As shown, step 395 occurs next. At step 395, for each identified person of the identified people, person information that corresponds to the identified person is obtained.

As shown, step 396 occurs next. At step 396, based on the obtained topic information and the obtained person information, for each identified person: a level of proficiency of the identified person in each of the identified topics is determined. As shown, step 397 occurs next. At step 397, based on the obtained topic information and the obtained person information, for each identified person: for each of the identified topics, whether the determined level of proficiency of the identified person meets a threshold that is associated with the identified topic is evaluated. As shown, step 398 occurs next. At step 398, based on the obtained topic information and the obtained person information, for each identified person: for each determined level of proficiency that does not meet the threshold that is associated with the identified topic, a remedy is suggested. The process may then advance to a return block, where other processing is resumed.

### Illustrative Devices/Operating Environments

FIG. 4 is a diagram of environment 400 in which aspects of the technology may be practiced. As shown, environment 400 includes computing devices 410, as well as network nodes 420, connected via network 430. Even though particular components of environment 400 are shown in FIG. 4, in other examples, environment 400 can also include additional and/or different components. For example, in certain examples, the environment 400 can also include network storage devices, maintenance managers, and/or other suitable components (not shown). Computing devices 410 shown in FIG. 4 may be in various locations, including a local computer, on premise, in the cloud, or the like. For example, computer devices 410 may be on the client side, on the server side, or the like.

As shown in FIG. 4, network 430 can include one or more network nodes 420 that interconnect multiple computing devices 410, and connect computing devices 410 to external network 440, e.g., the Internet or an intranet. For example, network nodes 420 may include switches, routers, hubs, network controllers, or other network elements. In certain examples, computing devices 410 can be organized into racks, action zones, groups, sets, or other suitable divisions. For example, in the illustrated example, computing devices 410 are grouped into three host sets identified individually as first, second, and third host sets 412a-112c. In the illustrated example, each of host sets 412a-112c is operatively coupled to a corresponding network node 420a-120c, respectively, which are commonly referred to as “top-of-rack” or “TOR” network nodes. TOR network nodes 420a-120c can then be operatively coupled to additional network nodes 420 to form a computer network in a hierarchical, flat, mesh, or other suitable types of topology that allows communications between computing devices 410 and external network 440. In other examples, multiple host sets 412a-112c may share a single network node 420. Computing devices 410 may be virtually any type of general—or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 410 may be individually configured to provide computing, storage, and/or other suitable computing services.

In some examples, one or more of the computing devices 410 is a device that is configured to be at least part of a system for detecting terminology understanding mismatch candidates.

### Illustrative Computing Device

FIG. 5 is a diagram illustrating one example of computing device 500 in which aspects of the technology may be practiced. Computing device 500 may be virtually any type of general—or specific-purpose computing device. For example, computing device 500 may be a user device such as a desktop computer, a laptop computer, a tablet computer, a display device, a camera, a printer, or a smartphone. Likewise, computing device 500 may also be a server device such as an application server computer, a virtual computing host computer, or a file server computer, e.g., computing device 500 may be an example of computing device 410 or network node 420 of FIG. 4. Likewise, computer device 500 may be an example any of the devices, a device within any of the distributed systems, illustrated in or referred to in any of the above figures, as discussed in greater detail below. As illustrated in FIG. 5, computing device 500 may include processing circuit 510, operating memory 520, memory controller 530, bus 540, data storage memory 550, input interface 560, output interface 570, and network adapter 580. Each of these afore-listed components of computing device 500 includes at least one hardware element.

Computing device 500 includes at least one processing circuit 510 configured to execute instructions, such as instructions for implementing the herein-described workloads, processes, and/or technology. Processing circuit 510 may include a microprocessor, a microcontroller, a graphics processor, a coprocessor, a field-programmable gate array, a programmable logic device, a signal processor, and/or any other circuit suitable for processing data. The aforementioned instructions, along with other data (e.g., datasets, metadata, operating system instructions, etc.), may be stored in operating memory 520 during run-time of computing device 500. Operating memory 520 may also include any of a variety of data storage devices/components, such as volatile memories, semi-volatile memories, random access memories, static memories, caches, buffers, and/or other media used to store run-time information. In one example, operating memory 520 does not retain information when computing device 500 is powered off. Rather, computing device 500 may be configured to transfer instructions from a non-volatile data storage component (e.g., data storage component 550) to operating memory 520 as part of a booting or other loading process. In some examples, other forms of execution may be employed, such as execution directly from data storage component 550, e.g., eXecute In Place (XIP).

Operating memory 520 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), magnetoresistive random access memory (MRAM), pseudorandom random access memory (PSRAM), and/or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 510 via memory controller 530 in channels. One example of computing device 500 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 520 specifically does not include or encompass communications media, any communications medium, or any signals per se.

Memory controller 530 is configured to interface processing circuit 510 to operating memory 520. For example, memory controller 530 may be configured to interface commands, addresses, and data between operating memory 520 and processing circuit 510. Memory controller 530 may also be configured to abstract or otherwise manage certain aspects of memory management from or for processing circuit 510. Although memory controller 530 is illustrated as single memory controller separate from processing circuit 510, in other examples, multiple memory controllers may be employed, memory controller(s) may be integrated with operating memory 520, and/or the like. Further, memory controller(s) may be integrated into processing circuit 510. These and other variations are possible.

In computing device 500, data storage memory 550, input interface 560, output interface 570, and network adapter 580 are interfaced to processing circuit 510 by bus 540. Although FIG. 5 illustrates bus 540 as a single passive bus, other configurations, such as a collection of buses, a collection of point-to-point links, an input/output controller, a bridge, other interface circuitry, and/or any collection thereof may also be suitably employed for interfacing data storage memory 550, input interface 560, output interface 570, and/or network adapter 580 to processing circuit 510.

In computing device 500, data storage memory 550 is employed for long-term non-volatile data storage. Data storage memory 550 may include any of a variety of non-volatile data storage devices/components, such as non-volatile memories, disks, disk drives, hard drives, solid-state drives, and/or any other media that can be used for the non-volatile storage of information. However, data storage memory 550 specifically does not include or encompass communications media, any communications medium, or any signals per se. In contrast to operating memory 520, data storage memory 550 is employed by computing device 500 for non-volatile long-term data storage, instead of for run-time data storage.

Also, computing device 500 may include or be coupled to any type of processor-readable media such as processor-readable storage media (e.g., operating memory 520 and data storage memory 550) and communication media (e.g., communication signals and radio waves). While the term processor-readable storage media includes operating memory 520 and data storage memory 550, the term “processor-readable storage media,” throughout the specification and the claims, whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 500 also includes input interface 560, which may be configured to enable computing device 500 to receive input from users or from other devices. In addition, computing device 500 includes output interface 570, which may be configured to provide output from computing device 500. In one example, output interface 570 includes a frame buffer, graphics processor, graphics processor or accelerator, and is configured to render displays for presentation on a separate visual display device (such as a monitor, projector, virtual computing client computer, etc.). In another example, output interface 570 includes a visual display device and is configured to render and present displays for viewing. In yet another example, input interface 560 and/or output interface 570 may include a universal asynchronous receiver/transmitter (UART), a Serial Peripheral Interface (SPI), Inter-Integrated Circuit (I2C), a General-purpose input/output (GPIO), and/or the like. Moreover, input interface 560 and/or output interface 570 may include or be interfaced to any number or type of peripherals.

In the illustrated example, computing device 500 is configured to communicate with other computing devices or entities via network adapter 580. Network adapter 580 may include a wired network adapter, e.g., an Ethernet adapter, a Token Ring adapter, or a Digital Subscriber Line (DSL) adapter. Network adapter 580 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 500 is illustrated with certain components configured in a particular arrangement, these components and arrangements are merely one example of a computing device in which the technology may be employed. In other examples, data storage memory 550, input interface 560, output interface 570, or network adapter 580 may be directly coupled to processing circuit 510 or be coupled to processing circuit 510 via an input/output controller, a bridge, or other interface circuitry. Other variations of the technology are possible.

Some examples of computing device 500 include at least one memory (e.g., operating memory 520) having processor-executable code stored therein, and at least one processor (e.g., processing unit 510) that is adapted to execute the processor-executable code, wherein the processor-executable code includes processor-executable instructions that, in response to execution, enables computing device 500 to perform actions, where the actions may include, in some examples, actions for one or more processes described herein, such as the process shown in FIG. 3, as discussed in greater detail above.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “cloud” or “cloud computing” refers to shared pools of configurable computer system resources and higher-level services over a wide-area network, typically the Internet. “Edge” devices refer to devices that are not themselves part of the cloud but are devices that serve as an entry point into enterprise or service provider core networks.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device including at least one memory having processor-executable code stored therein and at least one processor that is adapted to execute the processor-executable code, wherein the processor-executable code includes processor-executable instructions that, in response to execution, enable the device to perform actions, including:
receiving input content;
identifying, from a plurality of topics, topics associated with the input content;
for each identified topic of the identified topics, obtaining, from a knowledge base, topic information that corresponds to the identified topic;
identifying people associated with the input content;
for each identified person of the identified people, obtaining, from the knowledge base, person information that corresponds to the identified person; and
based on the obtained topic information and the obtained person information, for each identified person:
determining a level of proficiency of the identified person in each of the identified topics;
evaluating, for each of the identified topics, whether the determined level of proficiency of the identified person meets a threshold that is associated with the identified topic; and
for each determined level of proficiency that does not meet the threshold that is associated with the identified topic, suggesting a remedy.

2. The apparatus of claim 1, wherein the input content includes at least one of a document, an email, a text message, an instant message, a website, or speech converted to text.

3. The apparatus of claim 1, wherein the obtained topic information includes a topic vector for each of the identified topics, wherein the obtained person information includes a person vector for each identified person, and wherein each of the topic vectors and each of the person vectors is a vector of floating-point numbers.

4. The apparatus of claim 1, wherein identifying topics associated with the input content is accomplished with a machine-learning model that maps that input content into a semantic space.

5. The apparatus of claim 1, wherein the obtained topic information includes a topic vector for each of the identified topics, wherein the obtained person information includes a person vector for each identified person, and wherein each of the topic vectors and each of the person vectors was generated by a machine-learning model.

6. The apparatus of claim 1, wherein the obtained topic information includes a topic vector for each of the identified topics, and wherein each of the topic vectors was generated by a machine-learning model that mapped that corresponding topic into a semantic space.

7. The apparatus of claim 1, wherein suggesting the remedy may include suggesting a relevant document.

8. The apparatus of claim 1, wherein suggesting the remedy may include a suggested clarification of terminology used in the input content.

9. The apparatus of claim 1, wherein the people associated with the input content include recipients of the input content.

10. A method, comprising:
mapping input content into a semantic space to identify, from a plurality of topics, topics associated with input content;
for each identified topic of the identified topics, retrieving a topic vector that corresponds to the identified topic;
identifying people associated with the input content;
for each identified person of the identified people, retrieving a person vector that corresponds to the identified person; and
based on the retrieved topic vectors and the retrieved person vectors, for each identified person:
determining a level of proficiency of the identified person in each of the identified topics;
evaluating, for each of the identified topics, whether the determined level of proficiency of the identified person meets a threshold that is associated with the identified topic; and
for each determined level of proficiency that does not meet the threshold that is associated with the identified topic, suggesting a remedy.

11. The method of claim 10, wherein the input content includes at least one of a document, an email, a text message, an instant message, a website, or speech converted to text.

12. The method of claim 10, wherein each of the topic vectors and each of the person vectors is a vector of floating-point numbers.

13. The method of claim 10, wherein each of the topic vectors and each of the person vectors was generated by a machine-learning model.

14. The method of claim 10, wherein each of the topic vectors was generated by a machine-learning model that mapped that corresponding topic into the semantic space.

15. A processor-readable storage medium, having stored thereon processor-executable code that, upon execution by at least one processor, enables actions, comprising:
receiving input content;
determining, from a plurality of topics, topics associated with the input content;
for each determined topic of the determined topics, from a knowledge base, obtaining topic information that corresponds to the identified topic;
determining people associated with the input content;
for each determined person of the determined people, obtaining, from the knowledge base, person information that corresponds to the determined person; and
based on the obtained topic vectors and the obtained person vectors, for each determined person:
evaluating a skill level of the determined person in each of the determined topics;
determining, for each of the determined topics, whether the evaluated skill level of the determined person meets a threshold that is associated with the determined topic; and
for each evaluated skill level that does not meet the threshold that is associated with the determined topic, communicating a suggested remedy.

16. The processor-readable storage medium of claim 15, wherein the input content includes at least one of a document, an email, a text message, an instant message, a website, or speech converted to text.

17. The processor-readable storage medium of claim 15, wherein the obtained topic information includes a topic vector for each of the identified topics, wherein the obtained person information includes a person vector for each identified person, and wherein each of the topic vectors and each of the person vectors is a vector of floating-point numbers.

18. The processor-readable storage medium of claim 15, wherein determining topics associated with the input content is accomplished with a machine-learning model that maps that input content into a semantic space.

19. The processor-readable storage medium of claim 15, wherein the obtained topic information includes a topic vector for each of the identified topics, wherein the obtained person information includes a person vector for each identified person, and wherein each of the topic vectors and each of the person vectors was generated by a machine-learning model.

20. The processor-readable storage medium of claim 15, wherein the obtained topic information includes a topic vector for each of the identified topics, and wherein each of the topic vectors was generated by a machine-learning model that mapped that corresponding topic into the semantic space.
